(19) United States
(12) Patent Application Publication
(10) Pub. No.: US 2026/0368692 A1
(43) Pub. Date: Nov. 19, 2026

(54) Systems and Methods of Inventory Supply Planning Based on Item Substitution

(71) Applicant: Blue Yonder Group, Inc., Scottsdale, AZ (US)

(72) Inventors: Sukesh Dixit, Pflugerville, TX (US); Raghuveer Prasad Nagar, Kota (IN)

(21) Appl. No.: 19/750,491

(22) Filed: Jul. 22, 2026

Related U.S. Application Data
(63) Continuation of application No. 18/824,703, filed on Sep. 4, 2024.
(60) Provisional application No. 63/602,841, filed on Nov. 27, 2023.
(60) Provisional application No. 63/602,845, filed on Nov. 27, 2023.
(60) Provisional application No. 63/602,846, filed on Nov. 27, 2023.
(60) Provisional application No. 63/603,933, filed on Nov. 29, 2023.

(51) Int. Cl. G06Q 10/087; G06Q 30/0202

(52) U.S. Cl. CPC G06Q 10/087; G06Q 30/0202

(57) ABSTRACT

A system and method are disclosed for generating an inventory supply plan based on predicted substitutions. The method includes determining a set of items for which a first item may be a potential substitute, detecting out of stock situations for the set of items, predicting expected substitutions of the first item for the set of items based on the detected out of stock situations, predicting additional inventory of the first item needed to fulfill the predicted substitutions of the first item, and generating an inventory supply plan that accounts for the predicted expected substitutions of the first item. The method further includes determining clusters of products for substitution based on product attributes and customer histories, where the expected substitutions are predicted in response to a search for an item and displaying an expected substitution instead of any out of stock item.

### CROSS-REFERENCE TO RELATED APPLICATIONS

This application is a continuation of U.S. Patent Application No. 18/824,703, filed Sep. 4, 2024, entitled “Systems and Methods of Inventory Supply Planning Based on Item Substitution,” which claims the benefit under 35 U.S.C. §199(e) to U.S. Provisional Application No. 63/602,841, filed Nov. 27, 2023, entitled “Recommending Substitute Items Based on their Fulfillment Constraints,” U.S. Provisional Application No. 63/602,845, filed Nov. 27, 2023, entitled “Inventory Supply Planning Based on Item Substitution,” U.S. Provisional Application No. 63/602,846, filed Nov. 27, 2023, entitled “Out-of-Stock Avoidance Through Proactive Substitution Recommendations,” and U.S. Provisional Application No. 63/603,933 filed Nov. 29, 2023, entitled “Inventory and Capacity Driven Product Substitution Recommendations.” U.S. Patent Application No. 18/824,703 and U.S. Provisional Application Nos. 63/602,841, 63/602,845, 63/602,846, and 63/603,933 are assigned to the assignee of the present application.

### TECHNICAL FIELD

The present disclosure relates generally to supply chain fulfillment and more specifically to recommending item substitutions.

### BACKGROUND

Enterprises often recommend substitute items to customers to increase profitability, retain customers, and promote a brand, among various other reasons. For example, an enterprise may offer a substitute item while selling an item, such as to present similar or better options to a customer, as well as fulfillment, such as to present alternative options when an item of customer interest is unavailable. Existing systems typically recommend substitute items based on catalog factors (e.g., explicit substitution definitions and matching or similar item attributes), inventory factors (e.g., availability of items), seller factors (e.g., profitability of items), and customer factors (e.g., customer item preferences). However, determining substitute items to recommend from such factors fails to account for fulfillment constraints associated with substitute items, such as, for example, warehouse resource capacity, inventory availability, out-of-stock situations resulting from lack of substitute item recommendation efficacy, and the like. Use of existing systems thus results in decreased customer satisfaction, increased conversion time, and lost sales, all of which are undesirable.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 illustrates a supply chain network, in accordance with a first embodiment;

FIG. 2 illustrates the substitution planning system, the archiving system, and the planning and execution system of FIG. 1 in greater detail, in accordance with an embodiment;

FIG. 3 illustrates an example method for generating substitution recommendations throughout a customer shopping journey, in accordance with an embodiment;

FIG. 4 illustrates an example data flow for determining optimal item substitution recommendations, in accordance with an embodiment; and

FIG. 5 illustrates a method for inventory supply plans based on predicted substitutions, in accordance with an embodiment.

### DETAILED DESCRIPTION

Aspects and applications of the invention presented herein are described below in the drawings and detailed description of the invention. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are illustrated or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

As described below, embodiments of the following disclosure provide systems and methods for recommending substitute items in a supply chain network based on order fulfillment constraints. Embodiments determine a set of items that a particular item may be a potential substitute for and proactively predict out-of-stock (OOS) situations for the set of items. Systems and methods disclosed herein may predict the likelihood of customers substituting the item for items in the determined set of items and predict additional inventory needed to fulfill the predicted substitutions. Embodiments further generate or update and thereafter implement one or more inventory supply plans that account for the predicted substitutions.

Systems and methods disclosed herein may provide substitute item recommendations for any products and services offered within a supply chain network to consumers of the products and services. Use of embodiments may increase the efficiency and efficacy of substitute item recommendations in supply chain networks, as well as reduce the occurrence of customer dissatisfaction by avoiding recommending substitute items that cannot be fulfilled on time or as promised due to logistical constraints or inventory unavailability. Embodiments utilize various streams of customer data to personalize substitute item recommendations. Implementation of the systems and method described herein may include the preregistration of users to data collection and processing services, such as tracking customer service interactions and social media interactions, to further protect user data privacy.

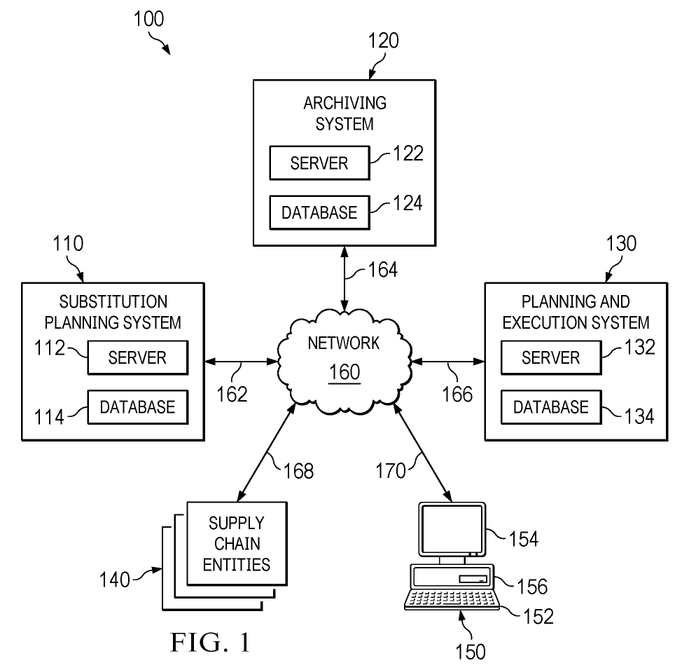

FIG. 1 illustrates supply chain network 100, in accordance with a first embodiment. Supply chain network 100 comprises substitution planning system 110 archiving system 120, planning and execution system 130, one or more supply chain entities 140, one or more computers 150, network 160, and one or more communication links 162-170. Although a single substitution planning system 110, a single archiving system 120, a single planning and execution system 130, one or more supply chain entities 140, one or more computers 150, a single network 160, and one or more communication links 162-170 are illustrated and described, embodiments contemplate any number of substitution planning systems, archiving systems, planning and execution systems, supply chain entities, computers, networks, or communication links, according to particular needs.

In one embodiment, substitution planning system 110 comprises server 112 and database 114. Although substitution planning system 110 is illustrated in FIG. 1 as comprising a single server 112 and a single database 114, embodiments contemplate substitution planning system 110 including any suitable number of servers, databases, serverless computing options, or data stores internal to, or externally coupled with, substitution planning system 110, according to particular needs. For the purposes of this disclosure, all instances of “server” are understood to include, according to embodiments, one or more embodiments of servers, serverless computing options, and/or other computing solutions, and all instances of “database” are understood to include, according to embodiments, databases, datastores, data stores, and/or other data storage systems, according to particular needs.

In embodiments, substitution planning system 110 recommends one or more substitute items to customers of supply chain network 100, such as a customer of a particular retailer or seller, based on fulfillment constraints of potential substitute items. As used herein, the word “item” may include both products and services sold or made available by one or more supply chain entities 140 of supply chain network 100. As described in further detail below, substitution planning system 110 may determine a set of items for which a particular item sold by a retailer or otherwise made available by one or more supply chain entities 140 of supply chain network 100 may be a substitute. Substitution planning system 110 may further detect and predict OOS situations for the set of items and predict a number of substitutions of the item for the set of items that are likely to occur. According to embodiments, substitution planning system 110 also predicts an additional amount of inventory of the item needed to fulfill the predicted substitutions and generates or updates one or more supply chain plans, including inventory supply plans, that account for the additional amount of inventory needed to fulfill the predicted substitutions.

Archiving system 120 comprises server 122 and database 124. Although archiving system 120 is illustrated as comprising single server 122 and single database 124, embodiments contemplate any suitable number of servers or databases internal to, or externally coupled with, archiving system 120. Server 122 of archiving system 120 may support one or more processes for receiving and storing data from planning and execution system 130 and/or one or more computers 150 of supply chain network 100. According to some embodiments, archiving system 120 comprises an archive of data received from planning and execution system 130 and/or one or more computers 150 of supply chain network 100 and provides archived data to substitution planning system 110 and/or planning and execution system 130. Server 122 may store the received data in database 124, which may comprise one or more databases or other data storage arrangements at one or more locations local to, or remote from, server 122.

According to an embodiment, planning and execution system 130 comprises server 132 and database 134. Supply chain planning and execution is typically performed by several distinct and dissimilar processes, including, for example, strategic assortment planning, demand forecasting, planning, operations planning, production planning, supply planning, distribution planning, execution, pricing, forecasting, transportation management, warehouse management, inventory management, fulfillment, procurement, and the like. Server 132 of planning and execution system 130 comprises one or more modules, such as, for example, a sourcing module, a scheduling module, and/or a pick-pack-ship module for performing one or more order fulfillment processes. Server 132 stores and retrieves data from database 134 or one or more locations in supply chain network 100. In addition, planning and execution system 130 operates on one or more computers 150 that are integral to, or separate from, the hardware and/or software that support archiving system 120 and substitution planning system 110.

One or more supply chain entities 140 may represent one or more suppliers, one or more manufacturers, one or more distribution centers, and one or more retailers in one or more supply chain networks, including one or more enterprises. One or more suppliers may be any suitable entity that offers to sell or otherwise provides one or more items or components to one or more manufacturers or buyers. One or more suppliers may, for example, receive an item from a first supply chain entity of one or more supply chain entities 140 in supply chain network 100 and provide the item to another supply chain entity of one or more supply chain entities 140, which in some embodiments may be a buyer, a customer, or an end user. Items may comprise, for example, components, materials, products, parts, supplies, or other items that may be used to produce products. In addition, or as an alternative, an item may comprise a supply or resource that is used to manufacture the item but does not become a part of the item. In embodiments, items may comprise a service, such as an installation service. One or more suppliers may comprise automated distribution systems that automatically transport items to one or more manufacturers based, at least in part, on a supply chain plan having fair-shared items or resources, a material or capacity reallocation, current and projected inventory levels, and/or one or more additional factors described herein.

A manufacturer may be any suitable entity that manufactures at least one product. A manufacturer may use one or more items during the manufacturing process to produce any manufactured, fabricated, assembled, or otherwise processed item, material, component, good, or product. In one embodiment, a product represents an item ready to be supplied to, for example, another supply chain entity of one or more supply chain entities 140, such as a supplier, an item that needs further processing, or any other item. A manufacturer may, for example, produce and sell a product to a supplier, another manufacturer, a distribution center, a retailer, a customer, or any other suitable person or an entity. Such manufacturers may comprise automated robotic production machinery that produce products based, at least in part, on a supply chain plan having fair-shared items or resources, a material or capacity reallocation, current and projected inventory levels, and/or one or more additional factors described herein.

One or more distribution centers may be any suitable entity that offers to sell or otherwise distributes at least one product to one or more retailers and/or customers. Distribution centers may, for example, receive a product from a first supply chain entity of one or more supply chain entities 140 in supply chain network 100 and store and transport the product for a second supply chain entity of one or more supply chain entities 140. Such distribution centers may comprise automated warehousing systems that automatically transport products to one or more retailers or customers and/or automatically remove an item from, or place an item into, inventory based, at least in part, on a supply chain plan having fair-shared items or resources, a material or capacity reallocation, current and projected inventory levels, and/or one or more additional factors described herein.

One or more retailers may be any suitable entity that obtains one or more products to sell to one or more customers. In addition, one or more retailers may sell, store, and supply one or more components and/or repair a product with one or more components. One or more retailers may comprise any online or brick and mortar location, including locations with shelving systems. Shelving systems may comprise, for example, various racks, fixtures, brackets, notches, grooves, slots, or other attachment devices for fixing shelves in various configurations. These configurations may comprise shelving with adjustable lengths, heights, and other arrangements, which may be adjusted by an employee of one or more retailers based on computer-generated instructions or automatically by machinery to place products in a desired location.

The same supply chain entity may simultaneously act as any one or more suppliers, manufacturers, distribution centers, and retailers. For example, one or more supply chain entities 140 acting as a manufacturer may produce a product, and the same entity may act as a supplier to supply a product to another supply chain entity of one or more supply chain entities 140. Although one example of supply chain network 100 is illustrated and described, embodiments contemplate any configuration of supply chain network 100 without departing from the scope of the present disclosure.

As illustrated in FIG. 1, supply chain network 100 comprising substitution planning system 110, archiving system 120, planning and execution system 130, and one or more supply chain entities 140 may operate on one or more computers 150 that are integral to, or separate from, the hardware and/or software that support substitution planning system 110, archiving system 120, planning and execution system 130, and one or more supply chain entities 140. One or more computers 150 may include any suitable input device 152, such as a keypad, mouse, touch screen, microphone, or other device to input information. Output device 154 may convey information associated with the operation of supply chain network 100, including digital or analog data, visual information, or audio information. One or more computers 150 may include fixed or removable computer-readable storage media, including a non-transitory computer-readable medium, magnetic computer disks, flash drives, CD-ROM, in-memory device, or other suitable media to receive output from and provide input to supply chain network 100.

One or more computers 150 may further include one or more processors 156 and associated memory to execute instructions and manipulate information according to the operation of supply chain network 100 and any of the methods described herein. In addition, or as an alternative, embodiments contemplate executing the instructions on one or more computers 150 that cause one or more computers 150 to perform functions of the methods. An apparatus implementing special purpose logic circuitry, such as, for example, one or more field-programmable gate arrays (FPGA) or application-specific integrated circuits (ASIC), may perform functions of the methods described herein. Further examples may also include articles of manufacture, including tangible non-transitory computer-readable media that have computer-readable instructions encoded thereon, and the instructions may comprise instructions to perform functions of the methods described herein.

In addition, or as an alternative, supply chain network 100 may comprise a cloud-based computing system having processing and storage devices at one or more locations local to, or remote from, substitution planning system 110, archiving system 120, planning and execution system 130, and one or more supply chain entities 140. In addition, each of one or more computers 150 may be a workstation, personal computer (PC), network computer, notebook computer, tablet, personal digital assistant (PDA), cell phone, telephone, smartphone, wireless data port, augmented or virtual reality headset, or any other suitable computing device. In an embodiment, one or more users may be associated with substitution planning system 110 and archiving system 120.

In one embodiment, substitution planning system 110 may be coupled with network 160 using more communication link 162, which may be any wireline, wireless, or other link suitable to support data communications between substitution planning system 110 and network 160 during operation of supply chain network 100. Archiving system 120 may be coupled with network 160 using communication link 164, which may be any wireline, wireless, or other link suitable to support data communications between archiving system 120 and network 160 during operation of supply chain network 100. Planning and execution system 130 may be coupled with network 160 using communication link 166, which may be any wireline, wireless, or other link suitable to support data communications between planning and execution system 130 and network 160 during operation of supply chain network 100. One or more supply chain entities 140 may be coupled with network 160 using communication link 168, which may be any wireline, wireless, or other link suitable to support data communications between one or more supply chain entities 140 and network 160 during operation of supply chain network 100. One or more computers 150 may be coupled with network 160 using communication link 170, which may be any wireline, wireless, or other link suitable to support data communications between one or more computers 150 and network 160 during operation of supply chain network 100. Although communication links 162-170 are illustrated as generally coupling substitution planning system 110, archiving system 120, planning and execution system 130, one or more supply chain entities 140, and one or more computers 150 to network 160, any of substitution planning system 110, archiving system 120, planning and execution system 130, one or more supply chain entities 140, and one or more computers 150 may communicate directly with each other, according to particular needs.

In another embodiment, network 160 includes the Internet and any appropriate local area networks (LANs), metropolitan area networks (MANs), or wide area networks (WANs) coupling substitution planning system 110, archiving system 120, planning and execution system 130, one or more supply chain entities 140, and one or more computers 150. For example, data may be maintained locally to, or externally of, substitution planning system 110, archiving system 120, planning and execution system 130, one or more supply chain entities 140, and one or more computers 150 and made available to one or more associated users of substitution planning system 110, archiving system 120, planning and execution system 130, one or more supply chain entities 140, and one or more computers 150 using network 160 or in any other appropriate manner. For example, data may be maintained in a cloud database at one or more locations external to substitution planning system 110, archiving system 120, planning and execution system 130, one or more supply chain entities 140, and one or more computers 150 and made available to one or more associated users of substitution planning system 110, archiving system 120, planning and execution system 130, one or more supply chain entities 140, and one or more computers 150 using the cloud or in any other appropriate manner. Those skilled in the art will recognize that the complete structure and operation of network 160 and other components within supply chain network 100 are not depicted or described. Embodiments may be employed in conjunction with known communications networks and other components.

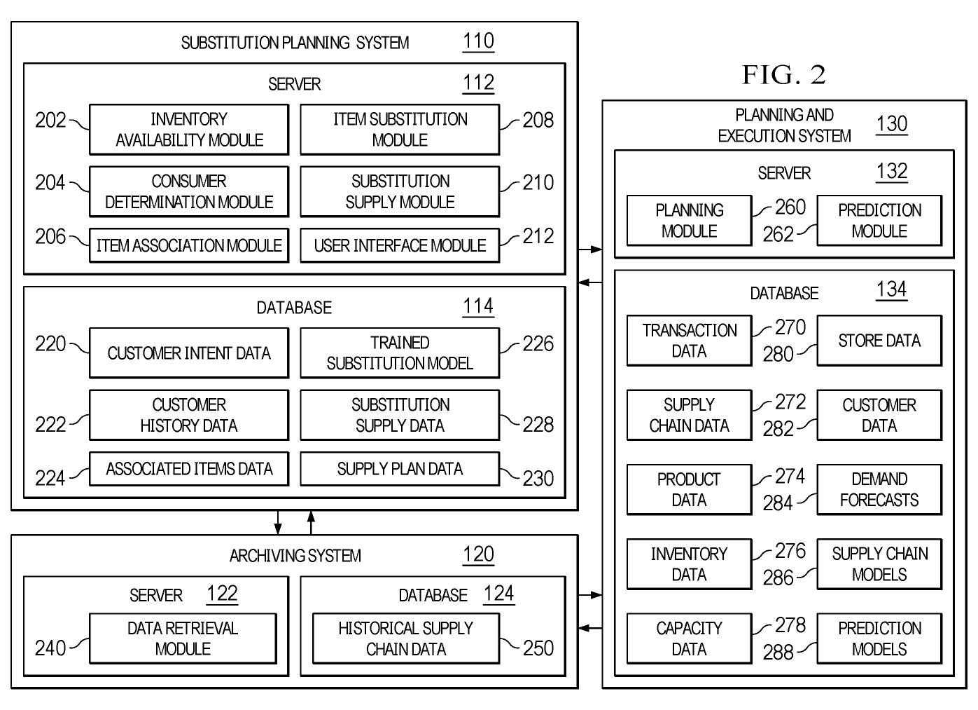

FIG. 2 illustrates substitution planning system 110, archiving system 120, and planning and execution system 130 of FIG. 1 in greater detail, in accordance with an embodiment. Substitution planning system 110 may comprise server 112 and database 114, as described above. Although substitution planning system 110 is illustrated as comprising a single server 112 and a single database 114, embodiments contemplate any suitable number of servers or databases internal to, or externally coupled with, substitution planning system 110.

Server 112 of substitution planning system 110 comprises inventory availability module 202, consumer determination module 204, item association module 206, item substitution module 208, substitution supply module 210, and user interface module 212. Although server 112 is illustrated and described as comprising a single inventory availability module 202, a single consumer determination module 204, a single item association module 206, a single item substitution module 208, a single substitution supply module 210, and a single user interface module 212, embodiments contemplate any suitable number or combination of these located at one or more locations local to, or remote from, substitution planning system 110, such as on multiple servers or computers 150 at one or more locations in supply chain network 100.

In an embodiment, inventory availability module 202 detects when an item sold by one or more supply chain entities 140 is currently unavailable or expected to become unavailable. For example, an item may be unavailable due to a lack of stock for the item or because an item is no longer produced or sold. Inventory availability module 202 may detect item unavailability by, for example, analyzing and comparing inventory data 276 to a cart or order placed by a customer of supply chain network 100. According to embodiments, when inventory availability module 202 determines that an item is unavailable, substitution planning system 110 begins a process to recommend one or more substitute items for the unavailable item. Inventory availability module 202 may also proactively predict when OOS situations may occur for an item. For example, by using predicted or forecasted demand for an item and comparing supply visibility for the item with the forecasted demand, inventory availability module 202 may predict that the forecasted demand is likely to outstrip the current inventory. Inventory availability module 202 may also use contextual data, such as weather data and local event data, to modify forecasted demand, as well as supply visibility to predict the likelihood of OOS situations.

Consumer determination module 204 utilizes customer intent data 220 to predict a true consumer or end-user of the unavailable item. In embodiments, the consumer of the unavailable item may be a different person from the shopper or user who places the order or is operating the cart for the unavailable item. For example, when a person attempts to purchase a gift for a friend, the person is the shopper, and the friend is the consumer. Consumer determination module 204 may use various information to predict the consumer, including a calendar or messages of the shopper, a purchase history of the shopper, an address associated with the consumer, or other customer intent data 220. Consumer determination module 204 may also derive consumer or customer preferences for substitutions, such as by using message data or profile data of the consumer or the customer. According to embodiments, consumer determination module 204 analyzes message or interaction data of customers using natural language processing (NLP) techniques or models, such as support vector machines (SVMs), term frequency (TF) models, term frequency inverse document frequency (TF-IDF) models, bag-of-words models, logistic regression models, Naïve Bayes models, decision trees, hidden Markov models, convolutional neural networks, recurrent neural networks, auto-encoder models, or NLP transformers. Although particular examples of NLP techniques are provided, consumer determination module 204 may utilize other NLP techniques to analyze message or interaction data of customers, according to particular needs.

Item association module 206 identifies other items that the predicted consumer currently uses and associates the unavailable item with one or more of the other items. For example, when the unavailable item is a computing accessory that uses a particular USB port, the one or more other items may be one or more computing devices associated with the consumer. In such an example, item association module 206 may associate the computing accessory with the computing devices. According to embodiments, item association module 206 uses information such as a purchase history associated with the consumer and product data 274, (e.g., catalog definitions of items), to associated items.

Item substitution module 208 determines one or more potential items to recommend as substitutions for the unavailable item. In embodiments, item substitution module 208 utilizes trained substitution model 226 to generate the potential substitution recommendations. Using data associated with the consumer predicted by consumer determination module 204, item substitution module 208 may recommend potential substitute items that are personalized to a consumer rather than just for the shopper. For example, when a shopper attempts to buy a book for a consumer that is unavailable, item substitution module 208 recommends substitute items based on book preferences of the consumer rather than on book preferences of the shopper. Item substitution module 208 may further assign a score to each of the one or more potential substitute items that corresponds to the likelihood of the consumer accepting each potential substitute item as a substitute for the unavailable item and rank the one or more potential substitute items accordingly.

Substitution supply module 210 determines, for a particular item, one or more items for which the item may be a potential substitute. Substitution supply module 210 may use predicted OOS situations for the one or more items to predict a number of substitutions that are expected to occur. For example, substitution supply module 210 may use detected or predicted OOS situations for the one or more items, substitution history of the one or more items (e.g., the frequency or percentage with which the item has been substituted for the one or more items in the past), and the particular customers or customer clusters associated with predicted demand for the one or more items to predict the number of expected substitutions. Substitution supply module 210 may further use the predicted number of expected substitutions along with a cancellation and return history for orders that include the item when ordered as a substitute to predict an additional inventory quantity for the item needed to fulfill all predicted substitutions. In embodiments, substitution supply module 210 generates or updates one or more supply chain plans or inventory plans using the predicted additional inventory quantity of the item needed to fulfill the predicted substitutions, such as to stock additional inventory of the item at one or more locations of one or more supply chain entities 140 to ensure sufficient capacity to fulfill the item as a substitute item for the one or more items. In addition, or as an alternative, the predicted additional inventory quantity for the item may be used by a supply chain planning module of supply chain network 100, such as planning module 260 of planning and execution system 130, to generate or update the one or more supply chain plans or inventory supply plans.

User interface module 212 generates and displays a user interface (UI), such as, for example, a graphical user interface (GUI), that displays supply plan data 230 or any other data of substitution planning system 110 in charts, graphs, histograms, or any other visual representations. According to embodiments, user interface module 212 displays a GUI comprising interactive graphical elements for selecting one or more substitute item recommendations and/or data of any kind stored in database 114 of substitution planning system 110 and, in response to the selection, displays the selected data on one or more display devices. In addition, or as an alternative, user interface module 212 may generate non-visual interfaces, such as voice-based virtual assistants, email messages, or other text-based messages, and present substitution recommendations to customers over such voice-based or text-based interfaces. In some embodiments, user interface module 212 presents a website or an application associated with a seller or a retailer to customers of supply chain network 100 via one or more display devices. In such embodiments, user interface module 212 may present a GUI enabling a customer to accept or reject the substitute item recommendation. User interface module 212 may also present a GUI enabling a user of substitution planning system 110 to approve or reject a substitution recommendation offer before presenting the recommendation to a customer.

Database 114 of substitution planning system 110 may comprise one or more databases or other data storage arrangements at one or more locations local to, or remote from, server 112. Database 114 of substitution planning system 110 comprises, for example, customer intent data 220, customer history data 222, associated items data 224, trained substitution model 226, substitution supply data 228, and supply plan data 230. Although database 114 of substitution planning system 110 is illustrated and described as comprising customer intent data 220, customer history data 222, associated items data 224, trained substitution model 226, substitution supply data 228, and supply plan data 230, embodiments contemplate any suitable number or combination of data located at one or more locations local to, or remote from, substitution planning system 110, according to particular needs.

In an embodiment, customer intent data 220 comprises data used by consumer determination module 204 to predict a consumer of a particular item. For example, customer intent data 220 may include a shipping address for an order and whether that shipping address is associated with the shopper or a different person. Customer intent data 220 may also include a calendar of the shopper that indicates upcoming events, such as a birthday party for another person, which may indicate that a purchase is for the other person rather than the shopper. Customer intent data 220 may further include messages of the shopper, a purchase history of the shopper, and/or delivery preferences of the shopper. According to embodiments, customer intent data 220 also includes contextual data affecting customer behavior, such as weather or weather forecast data, as well as data of upcoming local events or holidays that may impact customer shopping behavior. Customer intent data 220 may be obtained from archiving system 120 and used by inventory availability module 202 to predict OOS situations for items and by consumer determination module 204 to predict a consumer for a particular order.

Customer history data 222 comprises data of a shopper or consumer that indicates other items that the shopper or consumer may already have. For example, when consumer determination module 204 predicts Person B as the consumer for an order placed by Shopper A, customer history data 222 may include customer service data associated with Person B that indicates what items Person B already owns or uses, a purchase history of Person B that indicates what items Person B has previously purchased, or other data associated with Person B that may indicate what other items Person B already owns, other than the unavailable item of an order. In embodiments, customer history data 222 also includes customer calendar data, social media data associated with customers, customer service interactions taking place after order placement, IoT data collected from IoT devices associated with customers, and customer profiles and preferences. Customer history data 222 may further include customer interactions with customer service channels or self-service channels, including call center interactions, website or app interactions, social media interactions, in-person interactions, email interactions, or any other interactions with customer service associated with supply chain network 100. In embodiments, customer history data 222 comprises various data related to groups of customers or all customers of supply chain network 100, such as customer clusters, customer segments that include a particular customer, or any other grouping of customers based on similarity, customer profiles, customer preferences, or the like. Customer history data 222 may be obtained from archiving system 120 and used by inventory availability module 202 to predict OOS situations for items and by consumer determination module 204 to predict a consumer for a particular order.

Associated items data 224 comprises items owned by a consumer which are associated with an unavailable item. For example, when the unavailable item is a particular pair of headphones, associated items data 224 may include other items that the consumer owns which are compatible with the headphones. In embodiments, item association module 206 generates and stores associated items data 224 and item substitution module 208 uses associated items data 224 to determine one or more potential substitute items for the unavailable item, as disclosed above.

Trained substitution model 226 comprises a trained machine learning (ML) or artificial intelligence (AI) model used to recommend substitute items to a consumer. Trained substitution model 226 may take customer preferences, associations with items in-use by the consumer, product classifications, consumer clusters, UI analytics, previously-used substitutions, purchase history, user preferences on conditions for substitution, and a profitability of the items to generate recommended substitute items as input to generate substitute item recommendations. In embodiments, trained substitution model 226 outputs a list of recommended substitutions ranked by a score that indicates a predicted suitability of each potential substitute item. Trained substitution model 226 may be trained using training data comprising customer intent data 220 and customer history data 222.

Substitution supply data 228 comprises data related to additional inventory needed to fulfill predicted substitutions for a particular item of supply chain network 100. By way of example only and not by way of limitation, item substitution module 208 may determine a first brand of butter sold by a grocery store to be a potential substitute for one or more other butter brands sold by the grocery store. In this example, substitution supply data 228 may include a list of the one or more other butter brands for which the first brand of butter may be a substitute, and well as predicted OOS situations for the one or more other butter brands throughout supply chain network 100. Substitution supply data 228 may also include a predicted number of total substitutions using the first brand of butter and an additional quantity of inventory of the first brand of butter needed to fulfill the predicted number of total substitutions. In embodiments, substitution supply data 228 is generated by substitution supply module 210 and used by substitution supply module 210 or planning module 260 of planning and execution system 130 to generate or update one or more supply chain plans or inventory supply plans.

Supply plan data 230 comprises one or more supply chain plans or inventory supply plans which include an additional quantity of inventory for an item predicted to be necessary to fulfill all predicted substitution of the item for other items of supply chain network 100. In embodiments, the supply chain plans of supply plan data 230 may be executed by supply chain network 100, such as via planning and execution system 130 or via automated machinery of one or more supply chain entities 140, to alter the distribution of inventory for the item throughout supply chain network 100, such as by increasing the quantity of the item sourced from outside supply chain network 100 or increasing the production output of the item. Supply plan data 230 may be generated by substitution supply module 210 or planning module 260 of planning and execution system 130 and used by user interface module 212 to display one or more supply chain plans or inventory supply plans to a user of substitution planning system 110. In addition, or as an alternative, supply plan data 230 may be used by one or more modules of planning and execution system 130 or by one or more supply chain entities 140 to implement one or more supply chain plans or inventory supply plans.

As discussed above, archiving system 120 comprises server 122 and database 124. Although archiving system 120 is illustrated as comprising a single server 122 and a single database 124, embodiments contemplate any suitable number of servers or databases internal to, or externally coupled with, archiving system 120.

Server 122 of archiving system 120 comprises data retrieval module 240. Although server 122 is illustrated and described as comprising a single data retrieval module 240, embodiments contemplate any suitable number or combination of data retrieval modules located at one or more locations local to, or remote from, archiving system 120, such as on multiple servers or computers 150 at one or more locations in supply chain network 100.

In one embodiment, data retrieval module 240 of archiving system 120 receives historical supply chain data 250 from planning and execution system 130 and one or more supply chain entities 140 and stores received historical supply chain data 250 in archiving system 120 database 124. According to one embodiment, data retrieval module 240 may prepare historical supply chain data 250 for use as training data by checking historical supply chain data 250 for errors and transforming historical supply chain data 250 to normalize, aggregate, and/or rescale historical supply chain data 250 to allow direct comparison of data received from planning and execution system 130, one or more supply chain entities 140, and/or one or more other locations local to, or remote from, archiving system 120. According to embodiments, data retrieval module 240 may receive data from one or more sources external to supply chain network 100, such as, for example, weather data, special events data, social media data, calendar data, and the like, and store the received data as historical supply chain data 250.

Database 124 of archiving system 120 may comprise one or more databases or other data storage arrangements at one or more locations local to, or remote from, server 122. Database 124 of archiving system 120 comprises, for example, historical supply chain data 250. Although database 124 of archiving system 120 is illustrated and described as comprising historical supply chain data 250, embodiments contemplate any suitable number or combination of data located at one or more locations local to, or remote from, archiving system 120, according to particular needs.

Historical supply chain data 250 comprises historical data received from substitution planning system 110, planning and execution system 130, one or more supply chain entities 140, and/or one or more computers 150. Historical supply chain data 250 may comprise, for example, weather data, special events data, social media data, calendar data, and the like. In an embodiment, historical supply chain data 250 may comprise, for example, historic sales patterns, prices, promotions, weather conditions, and other factors influencing future demand of the number of one or more items sold in one or more stores over a time period, such as, for example, one or more days, weeks, months, or years, including, for example, a day of the week, a day of the month, a day of the year, a week of the month, a week of the year, a month of the year, special events, paydays, and the like.

As discussed above, planning and execution system 130 comprises server 132 and database 134. Although planning and execution system 130 is illustrated as comprising a single server 132 and a single database 134, embodiments contemplate any suitable number of servers or databases internal to, or externally coupled with, planning and execution system 130.

In embodiments, server 132 of planning and execution system 130 comprises planning module 260 and prediction module 262. Although server 132 is illustrated and described as comprising a single planning module 260 and a single prediction module 262, embodiments contemplate any suitable number or combination of planning modules and prediction modules located at one or more locations local to, or remote from, planning and execution system 130, such as on multiple servers or computers 150 at one or more locations in supply chain network 100.

Planning module 260 of planning and execution system 130 works in connection with prediction module 262 to generate a plan based on one or more predicted retail volumes, classifications, or other predictions. By way of example and not of limitation, planning module 260 may comprise a demand planner that generates a demand forecast for one or more supply chain entities 140. Planning module 260 may generate the demand forecast, at least in part, from predictions and calculated factor values for one or more causal factors received from prediction module 262. By way of a further example, planning module 260 may comprise an assortment planner and/or a segmentation planner that generates product assortments that match causal effects calculated for one or more customers or products by prediction module 262, which may provide for increased customer satisfaction and sales, as well as reduce costs for shipping and stocking products at stores where they are unlikely to sell.

Prediction module 262 of planning and execution system 130 applies samples of transaction data 270, supply chain data 272, product data 274, inventory data 276, capacity data 278, store data 280, customer data 282, demand forecasts 284, and other data to prediction models 288 to generate predictions and calculated factor values for one or more causal factors. Prediction module 262 of planning and execution system 130 may predict a volume Y (target) from a set of causal factors X along with causal factors strengths that describe the strength of each causal factor variable contributing to the predicted volume. According to some embodiments, prediction module 262 generates predictions at daily intervals. However, embodiments contemplate longer and shorter prediction phases that may be performed, for example, weekly, twice a week, twice a day, hourly, or the like.

Database 134 of planning and execution system 130 may comprise one or more databases or other data storage arrangements at one or more locations local to, or remote from, server 132. Database 134 of planning and execution system 130 comprises, for example, transaction data 270, supply chain data 272, product data 274, inventory data 276, capacity data 278, store data 280, customer data 282, demand forecasts 284, supply chain models 286, and prediction models 288. Although database 134 of planning and execution system 130 is illustrated and described as comprising transaction data 270, supply chain data 272, product data 274, inventory data 276, capacity data 278, store data 280, customer data 282, demand forecasts 284, supply chain models 286, and prediction models 288, embodiments contemplate any suitable number or combination of data located at one or more locations local to, or remote from, planning and execution system 130, according to particular needs.

Transaction data 270 of planning and execution system 130 may comprise recorded sales and returns transactions and related data, including, for example, a transaction identification, time and date stamp, channel identification (such as stores or online touchpoints), product identification, actual cost, selling price, sales volume, customer identification, promotions, and/or the like. In addition, transaction data 270 is represented by any suitable combination of values and dimensions, aggregated or disaggregated, such as, for example, sales per week, sales per week per location, sales per day, sales per day per season, or the like.

Supply chain data 272 may comprise any data of one or more supply chain entities 140 including, for example, item data, identifiers, metadata (comprising dimensions, hierarchies, levels, members, attributes, cluster information, and member attribute values), fact data (comprising measure values for combinations of members), business constraints, goals, and objectives of one or more supply chain entities 140.

Product data 274 of database 134 may comprise products identified by, for example, a product identifier (such as a Stock Keeping Unit (SKU), Universal Product Code (UPC), or the like) and one or more attributes and attribute types associated with the product ID. Product data 274 may comprise data about one or more products organized and sortable by, for example, product attributes, attribute values, product identification, product components, sales volume, demand forecast, or any stored category or dimension. Attributes of one or more products may be, for example, any categorical characteristic, structural characteristic, or quality of a product, and an attribute value may be a specific value or identity for the one or more products according to the categorical characteristic or quality, including, for example, physical parameters (such as, for example, size, weight, dimensions, color, and the like).

Inventory data 276 of database 134 may comprise any data relating to current or projected inventory quantities or states, order rules, or the like. For example, inventory data 276 may comprise the current level of inventory for each item at one or more stocking points across supply chain network 100. In addition, inventory data 276 may comprise order rules that describe one or more rules or limits on setting an inventory policy, including, but not limited to, a minimum order volume, a maximum order volume, a discount, and a step-size order volume, and batch quantity rules. According to some embodiments, planning and execution system 130 accesses and stores inventory data 276 in database 134, which may be used by planning and execution system 130 to place orders, set inventory levels at one or more stocking points, initiate manufacturing of one or more components, or the like.

In embodiments, inventory data 276 may also comprise one or more inventory policies. The inventory policies may comprise any suitable inventory policy describing the reorder point and target quantity, or other inventory policy parameters that set rules for planning and execution system 130 to manage and reorder inventory. The inventory policies may be based on target service level, demand, cost, fill rate, or the like. According to embodiments, the inventory policies comprise target service levels that ensure that a service level of one or more supply chain entities 140 is met with a set probability. For example, one or more supply chain entities 140 may set a service level at 95%, meaning one or more supply chain entities 140 sets the desired inventory stock level at a level that meets demand 95% of the time. Although a particular service level target and percentage is described, embodiments contemplate any service target or level, such as, for example, a service level of approximately 99% through 90%, a 75% service level, or any suitable service level, according to particular needs. Other types of service levels associated with inventory quantity or order quantity may comprise, but are not limited to, a maximum expected backlog and a fulfillment level. Once the service level is set, planning and execution system 130 may determine a replenishment order according to one or more replenishment rules, which, among other things, indicates to one or more supply chain entities 140 to determine or receive inventory to replace the depleted inventory. By way of example only and not by way of limitation, an inventory policy for non-perishable goods with linear holding and shorting costs comprises a min./max. (s,S) inventory policy. Other inventory policies may be used for perishable goods, such as fruit, vegetables, dairy, and fresh meat, as well as electronics, fashion, and similar items for which demand drops significantly after a next generation of electronic devices or a new season of fashion is released.

Capacity data 278 of database 134 may comprise any data relating to current or projected resource capacity values or states, order rules, or the like. For example, capacity data 278 may comprise the current level of capacity for each task at one or more locations across supply chain network 100. In addition, capacity data 278 may comprise order rules that describe one or more rules or limits on setting a capacity policy, including, but not limited to, a minimum order capacity, a maximum order capacity, a discount, a step-size order capacity, and batch quantity rules. According to some embodiments, planning and execution system 130 accesses and stores capacity data 278 in database 134, which may be used by planning and execution system 130 to place orders, set capacity levels at one or more locations in supply chain network 100, initiate manufacturing of one or more components, or the like.

In embodiments, capacity data 278 may include one or more capacity policies. The capacity policies may comprise any suitable capacity policy describing the reorder point and target quantity, or other capacity policy parameters that set rules for planning and execution system 130 to manage capacity. The capacity policies may be based on target service level, demand, cost, or the like. According to embodiments, the capacity policies comprise target service levels that ensure that a service level of one or more supply chain entities 140 is met with a set probability. For example, one or more supply chain entities 140 may set a service level at 95%, meaning one or more supply chain entities 140 sets the desired capacity level at a level that meets demand 95% of the time.

Store data 280 may comprise data describing the stores of one or more retailers and related store information. Store data 280 may comprise, for example, a store ID, store description, store location details, store location climate, store type, store opening date, lifestyle, store area (expressed in, for example, square feet, square meters, or other suitable measurement), latitude, longitude, and other similar data.

Customer data 282 of planning and execution system 130 may comprise customer identity information, including, for example, customer relationship management data, loyalty programs, and mappings between product purchases and one or more customers so that a customer associated with a transaction may be identified. Customer data 282 may further comprise data relating customer purchases to one or more products, geographical regions, store locations, or other types of dimensions. In an embodiment, customer data 282 may also comprise customer profile information, including demographic information and preferences, as well as product browsing data, customer service interaction data, and UI analytics data of customers.

Demand forecasts 284 of database 134 may indicate expected future demand based on, for example, any data relating to past sales, past demand, purchase data, promotions, events, or the like of one or more supply chain entities 140. Demand forecasts 284 may cover a time interval such as, for example, by the minute, by the hour, daily, weekly, monthly, quarterly, yearly, or any other suitable time interval, including substantially in real time. In some embodiments, demand may be modeled as a negative binomial or Poisson-Gamma distribution. According to other embodiments, the model also takes into account shelf-life of perishable goods (which may range from days (e.g., fresh fish or meat) to weeks (e.g., butter) or even months, before any unsold items have to be written off as waste) as well as influences from promotions, price changes, rebates, coupons, and even cannibalization effects within an assortment range. In addition, customer behavior is not uniform but varies throughout the week and is influenced by seasonal effects and the local weather, as well as many other contributing factors. Accordingly, even when demand generally follows a Poisson-Gamma model, the exact values of the parameters of the model may be specific to a single product to be sold on a specific day in a specific location or sales channel and may depend on a wide range of frequently changing influencing causal factors. By way of example only and not by way of limitation, an exemplary supermarket may stock twenty thousand items at one thousand locations. When each location of this exemplary supermarket is open every day of the year, planning and execution system 130 needs to calculate approximately 2 x 10 ^ 10 demand forecasts 284 each day to derive the optimal order volume for the next delivery cycle (e.g., three days).

Supply chain models 286 of database 134 comprise characteristics of a supply chain setup to deliver the customer expectations of a particular customer business model. These characteristics may comprise differentiating factors, such as, for example, MTO (Make-to-Order), ETO (Engineer-to-Order), or MTS (Make-to-Stock). However, supply chain models 286 may also comprise characteristics that specify the supply chain structure in even more detail, including, for example, specifying the type of collaboration with the customer (e.g., Vendor-Managed Inventory (VMI)), from where products may be sourced, and how products may be allocated, shipped, or paid for by particular customers. Each of these characteristics may lead to a different supply chain model. Prediction models 288 comprise one or more of the trained models used by planning and execution system 130 for predicting, among other variables, pricing, targeting, or retail volume, such as, for example, a forecasted demand volume for one or more products at one or more stores of one or more retailers based on the prices of the one or more products.

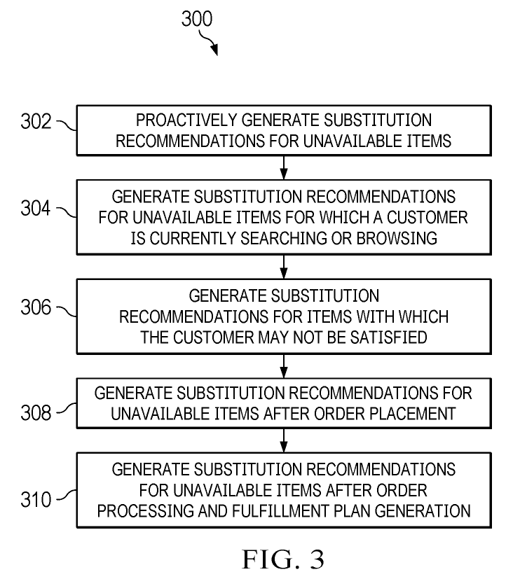

FIG. 3 illustrates example method 300 for generating substitution recommendations throughout a customer journey, in accordance with an embodiment. Method 300 may be performed by a substitution planning system, such as substitution planning system 110 of FIG. 1. Method 300 proceeds by one or more activities, which although described in a particular order, may be performed in one or more permutations, combinations, orders, or repetitions, according to particular needs. As described below, substitution planning system 110 performs activities of method 300 around various stages of an online shopping journey of a customer with a retailer.

At activity 302, substitution planning system 110 proactively generates substitution recommendations for unavailable items. For example, inventory availability module 202 of substitution planning system 110 detects potential OOS scenarios that may require substitution item recommendations. In such an example, a retailer may predict potential OOS scenarios in advance using forecasted demand and supply visibility, which inventory availability module 202 may analyze to detect the potential OOS scenarios as an event requiring substitute item recommendation. In embodiments, consumer determination module 204 of substitution planning system 110 determines customers that are likely to attempt purchases of the predicted OOS items using customer profiling and product parity groups, such as by determining that a customer orders a particular product every week from customer history data 222. Item substitution module 208 of substitution planning system 110 may then generate personalized substitution recommendations for customers that are likely to attempt to purchase the predicted OOS items. Although the example of predicting OOS scenarios of an item for proactive substitution recommendations is provided, embodiments contemplate substitution planning system 110 generating substitution recommendations in response to adjustments, such as warehouse count processes. According to embodiments, substitution planning system 110 performs activity 302 before the customer begins the shopping journey with the retailer.

At activity 304, substitution planning system 110 generates substitution recommendations for unavailable items for which the customer is currently searching or browsing. When the customer enters a search or begins browsing for a particular OOS item or an item category that includes one or more OOS items, inventory availability module 202 detects that the item is unavailable and requires substitution recommendations. Based, at least in part, on a consumer predicted by consumer determination module 204 and other items that the predicted consumer is currently using identified by item association module 206 of substitution planning system 110, item substitution module 208 may determine one or more potential items to recommend as substitutions to the customer. Upon item substitution module 208 recommending substitute items for the OOS item, user interface module 212 displays the substitute items instead of displaying OOS items as unavailable or not displaying OOS items to the customer.

At activity 306, after the customer adds an item to a shopping cart, substitution planning system 110 generates substitution recommendations for the item when customer behavior indicates that the customer may not completely satisfied with the item. For example, user interface module 212 may track continued navigation or renavigation by the customer to a product listing page (PLP) or product details page (PDP) of other related products to detect that the customer is not satisfied with the item. In response, item substitution module 208 may determine one or more additional items to recommend as substitutions to the customer, and user interface module 212 may present the recommended substitute items to the customer.

At activity 308, after the customer places an order for an item, substitution planning system 110 generates substitution recommendations for the item when the item becomes unavailable after the order has been placed. In some embodiments, substitution planning system 110 may generate substitution recommendations in response to inventory availability module 202 detecting that the item has become unavailable. In other embodiments, substitution planning system 110 may proactively respond to the OOS situation by inventory availability module 202 detecting that the item is predicted to be unavailable upon the time of order fulfillment and recommend one or more substitute items to the customer in advance of the unavailability.

At activity 310, after an order for an item is processed and a fulfillment plan for the order is generated, substitution planning system 110 generates substitution recommendations for the item when the item has no available inventory despite previous allocation of the order. Substitution planning system 110 may react to the OOS situation for the item by picking a substitute item determined using substitution input data collected throughout the customer journey, as described above, and pick the substitute item at fulfillment time.

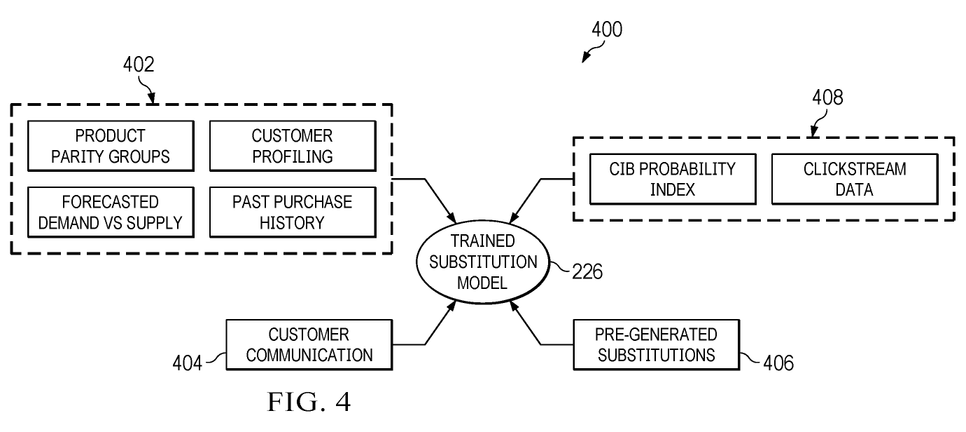

FIG. 4 illustrates example data flow 400 for determining optimal item substitution recommendations, in accordance with an embodiment. Data flow 400 illustrates data streams 402-408 which a substitution optimizer, such as trained substitution model 226, may use to generate potential substitute item recommendations. As illustrated, trained substitution model 226 may utilize customer and product data stream 402, which includes product parity group data, forecasted demand versus supply data, customer profiling data, and customer purchase history data to detect OOS scenarios in advance and generate substitutions for customers. As used herein, a product parity group refers to clusters of products. For example, item association module 206 may utilize one or more clustering algorithms that identify similar products based on product attributes and customer history data 222 to generate product parity groups that represent a meaningful classification of substitutable products based on product attributes. Customer profiling data may include customer clusters based on demographics, purchase intent, and coupon affinity, among other bases for clusters, classifications, or groups. Trained substitution model 226 may leverage customer profiling data to identify substitutions for groups of users and to generate finer personalized substitution recommendations for specific users. Trained substitution model 226 may also utilize customer communications data stream 404 (e.g., customer message data), pre-generated substitutions data stream 406 (e.g., pre-generated substitutions from one or more other substitution models), and tracking data stream 408, which includes customer intent-to-buy (CIB) probability index data and clickstream data, to determine substitute products to recommend.

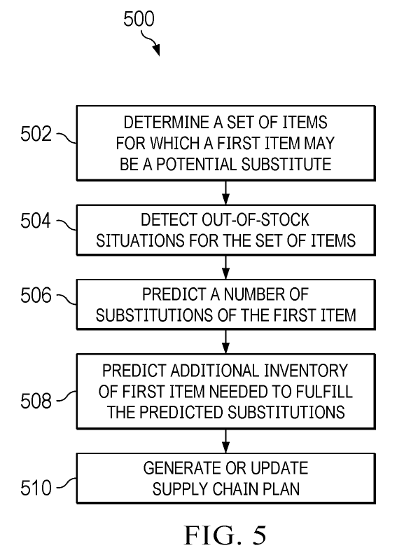

FIG. 5 illustrates method 500 for generating inventory supply plans based on predicted substitutions, in accordance with an embodiment. Method 500 may be performed by a substitution planning system, such as substitution planning system 110 of FIG. 1. Method 500 proceeds by one or more activities, which although described in a particular order, may be performed in one or more permutations, combinations, orders, or repetitions, according to particular needs.

At activity 502, substitution supply module 210 of substitution planning system 110 determines a set of items for which a first item may be a potential substitute. For example, an item may be a potential substitute for a set of items in the same product or service category as the item, or an item may be a potential substitute for a set of items for which the item has frequently been a substitute in the past. Substitution supply module 210 may determine the set of items for which the first item may be a potential substitute by analyzing customer behavior data and purchase history data. For example, substitution supply module 210 may analyze customer behavior data and purchase history data to determine that customers frequently buy a particular item as a substitute when they discover that their first-choice item is unavailable. In embodiments, substitution supply module 210 utilizes various data streams, which may include catalog data, purchase history data of customers, customer profile data, customer message data, and any other publicly available data of customers and/or of the item, to determine the set of items.

At activity 504, inventory availability module 202 of substitution planning system 110 detects OOS situations for the set of items determined at activity 502, such as by monitoring one or more communication channels from one or more supply chain entities 140 or by using supply visibility within supply chain network 100. Inventory availability module 202 may also predict OOS situations for the set of items determined at activity 502, such as by comparing current inventory availability for the set of items with forecasted or predicted demand for the set of items. In embodiments, inventory availability module 202 utilizes various data streams, including supply visibility data, predicted demand data or demand forecast data, and contextual data, such as weather data and local event data, to detect and predict OOS situations for the set of items.

At activity 506, substitution supply module 210 predicts a number of expected substitutions of the first item for the set of items based on the OOS situations detected and predicted at activity 504. For example, when substitution supply module 210 predicts a shortage of fifty units for a first product, and there has previously been a substitution rate of 50% of a second product for the first product, substitution supply module 210 may predict a total of twenty-five substitutions of the second product to be substituted for the first product. Although the example of substitution supply module 210 predicting the number of substitutions based on past substitution rates is provided for simplicity, substitution supply module 210 may consider other factors that influence the total predicted number of substitutions, according to particular needs. According to embodiments, substitution supply module 210 utilizes data streams, such as the OOS situations detected at activity 504, a substitution history for the first item or the set of items, and the customers or customer clusters associated with the predicted demand for the set of items, to predict the number of substitutions.

At activity 508, substitution supply module 210 predicts additional inventory of the first item needed to fulfill the number of substitutions of the first item predicted at activity 506. Substitution supply module 210 may predict the additional inventory needed by modifying the total predicted number of substitutions based on cancellation and return history when the first item has been ordered as a substitution in the past. For example, when the first item has a cancellation rate of 10% when ordered as a substitute for a second item, substitution supply module 210 may predict that 10% less than the initial prediction of substitutions of the first item is needed as inventory, though substitution supply module 210 may consider factors other than cancellation rates to predict the total additional inventory needed.

At activity 510, substitution supply module 210 generates or updates a supply chain plan or inventory supply plan for supply chain network 100 or one or more supply chain entities 140 that accounts for the predicted substitutions of the first item. In embodiments, the supply chain plan or inventory supply plan includes the additional inventory for the first item predicted at activity 508, such that all predicted substitutions of the first item for the second item are fulfilled by supply chain network 100. The supply chain plan or inventory supply plan may be automatically implemented by one or more pieces of automated machinery, such as the automated machinery described in greater detail above.

To further illustrate the operation of method 500 described above, the following example is provided. In this example, at activity 502, substitution supply module 210 determines that Item A sold by Retailer D may be substituted for Items B and C, also sold by Retailer D. At activity 504, inventory availability module 202 detects that Items B and C become OOS and Retailer D recommends Item A as a substitute for both Item B and Item C. At activity 508, substitution supply module 210 predicts an additional daily demand of one hundred items for the next three days for Item A because of the detected OOS situations for items B and C and the position of Item A as the closest substitute for items B and C. Based on the current inventory supply of two hundred units that Retailer D has on-hand, the predicted additional demand of one hundred units, and already placed purchase and transfer orders for Item A, substitution supply module 210 updates the supply chain plan to place additional purchase orders for Item A to obtain one hundred extra units of Item A for the next three days at activity 510, enabling Retailer D to fulfill all regular orders for Item A as well as orders where Item A is substituted for Items B and C.

Reference in the foregoing specification to “one embodiment”, “an embodiment”, or “some embodiments” means that a particular feature, structure, or characteristic described in connection with the embodiment is included in at least one embodiment of the invention. The appearances of the phrase “in one embodiment” in various places in the specification are not necessarily all referring to the same embodiment.

While the exemplary embodiments have been illustrated and described, it will be understood that various changes and modifications to the foregoing embodiments may become apparent to those skilled in the art without departing from the spirit and scope of the present invention.

What is claimed is:

1. A system for generating substitution recommendations throughout a customer journey, comprising:
a computer comprising a processor and a memory, the computer configured to:
generate one or more substitution recommendations for an unavailable item by detecting a predicted out-of-stock scenario for the unavailable item and determining one or more customers likely to attempt purchase of the unavailable item;
generate, in response to a search or browsing for the unavailable item, one or more substitution recommendations based on a predicted consumer and one or more items currently used by the predicted consumer;
generate, after the unavailable item is added to a shopping cart, one or more substitution recommendations in response to detected behavior indicating dissatisfaction with the unavailable item;
generate, after placement of an order for the unavailable item, one or more substitution recommendations when the unavailable item becomes unavailable or is predicted to be unavailable at fulfillment time; and
select, after processing of the order and generation of a fulfillment plan, a substitute item using substitution input data collected throughout the customer journey when allocated inventory is unavailable at fulfillment time.

2. The system of claim 1, wherein the predicted out-of-stock scenario is detected by comparing supply visibility for the unavailable item with a forecasted demand for the unavailable item.

3. The system of claim 1, wherein the one or more customers likely to attempt purchase of the unavailable item are determined using customer profiling and one or more product parity groups.

4. The system of claim 1, wherein the predicted consumer is distinct from a shopper operating the shopping cart and is predicted using customer intent data comprising at least one of a shipping-address association, shopper calendar data, shopper messages, shopper purchase history, and delivery preferences.

5. The system of claim 1, wherein the detected behavior indicating dissatisfaction comprises continued navigation or renavigation to a product listing page or a product detail page of a related product.

6. The system of claim 1, wherein the computer is further configured to display at least one of the one or more substitution recommendations in place of the unavailable item during the search or browsing.

7. The system of claim 1, wherein the computer is further configured to determine the one or more substitution recommendations using a trained substitution model that assigns a score to each of a plurality of potential substitute items corresponding to a predicted likelihood of consumer acceptance and ranks the plurality of potential substitute items according to the score.

8. A computer-implemented method for generating substitution recommendations throughout a customer journey, comprising:
generating, by a computer comprising a processor and a memory, one or more substitution recommendations for an unavailable item by detecting a predicted out-of-stock scenario for the unavailable item and determining one or more customers likely to attempt purchase of the unavailable item;
generating, by the computer in response to a search or browsing for the unavailable item, one or more substitution recommendations based on a predicted consumer and one or more items currently used by the predicted consumer;
generating, by the computer after the unavailable item is added to a shopping cart, one or more substitution recommendations in response to detected behavior indicating dissatisfaction with the unavailable item;
generating, by the computer after placement of an order for the unavailable item, one or more substitution recommendations when the unavailable item becomes unavailable or is predicted to be unavailable at fulfillment time; and
selecting, by the computer after processing of the order and generation of a fulfillment plan, a substitute item using substitution input data collected throughout the customer journey when allocated inventory is unavailable at fulfillment time.

9. The computer-implemented method of claim 8, wherein the predicted out-of-stock scenario is detected by comparing supply visibility for the unavailable item with a forecasted demand for the unavailable item.

10. The computer-implemented method of claim 8, wherein the one or more customers likely to attempt purchase of the unavailable item are determined using customer profiling and one or more product parity groups.

11. The computer-implemented method of claim 8, wherein the predicted consumer is distinct from a shopper operating the shopping cart and is predicted using customer intent data comprising at least one of a shipping-address association, shopper calendar data, shopper messages, shopper purchase history, and delivery preferences.

12. The computer-implemented method of claim 8, wherein the detected behavior indicating dissatisfaction comprises continued navigation or renavigation to a product listing page or a product detail page of a related product.

13. The computer-implemented method of claim 8, further comprising displaying, by the computer, at least one of the one or more substitution recommendations in place of the unavailable item during the search or browsing.

14. The computer-implemented method of claim 8, further comprising determining, by the computer, the one or more substitution recommendations using a trained substitution model that assigns a score to each of a plurality of potential substitute items corresponding to a predicted likelihood of consumer acceptance and ranks the plurality of potential substitute items according to the score.

15. A non-transitory computer-readable medium embodied with software for generating substitution recommendations throughout a customer journey, the software when executed configured to:
generate one or more substitution recommendations for an unavailable item by detecting a predicted out-of-stock scenario for the unavailable item and determining one or more customers likely to attempt purchase of the unavailable item;
generate, in response to a search or browsing for the unavailable item, one or more substitution recommendations based on a predicted consumer and one or more items currently used by the predicted consumer;
generate, after the unavailable item is added to a shopping cart, one or more substitution recommendations in response to detected behavior indicating dissatisfaction with the unavailable item;
generate, after placement of an order for the unavailable item, one or more substitution recommendations when the unavailable item becomes unavailable or is predicted to be unavailable at fulfillment time; and
select, after processing of the order and generation of a fulfillment plan, a substitute item using substitution input data collected throughout the customer journey when allocated inventory is unavailable at fulfillment time.

16. The non-transitory computer-readable medium of claim 15, wherein the predicted out-of-stock scenario is detected by comparing supply visibility for the unavailable item with a forecasted demand for the unavailable item.

17. The non-transitory computer-readable medium of claim 15, wherein the one or more customers likely to attempt purchase of the unavailable item are determined using customer profiling and one or more product parity groups.

18. The non-transitory computer-readable medium of claim 15, wherein the predicted consumer is distinct from a shopper operating the shopping cart and is predicted using customer intent data comprising at least one of a shipping-address association, shopper calendar data, shopper messages, shopper purchase history, and delivery preferences.

19. The non-transitory computer-readable medium of claim 15, wherein the detected behavior indicating dissatisfaction comprises continued navigation or renavigation to a product listing page or a product detail page of a related product.

20. The non-transitory computer-readable medium of claim 15, wherein the software when executed is further configured to display at least one of the one or more substitution recommendations in place of the unavailable item during the search or browsing.
